(19) United States
(12) Patent Application Publication
(10) Pub. No.: US 2004/0048631 A1
(43) Pub. Date: Mar. 11, 2004

(54) Handheld computer

(76) Inventors: Shih-Chieh Wang, Taipei (TW); Chien-Lung Huang, Taipei (TW); Hsi-Hsing Hsu, Taoyuani (TW)

Correspondence Address: BIRCH STEWART KOLASCH & BIRCH, PO BOX 747, FALLS CHURCH, VA, 22040-0747, US

(21) Appl. No.: 10/617,783

(22) Filed: Jul. 14, 2003

(30) Foreign Application Priority Data
Sep. 10, 2002 (TW) 91214202

(51) Int. Cl. H04B 7/15

(52) U.S. Cl. 455/550.1; 455/11.1; 455/566

(57) ABSTRACT

A handheld computer (10) is disclosed. The handheld computer includes a main body (12), a cellular phone device (not shown), a monitor (14) and a power switch (16). The monitor has a backlight (not shown). The cellular phone device is disposed in the main body. The monitor is disposed on the main body. The power switch is disposed on the main body and has a pushbutton (161). The pushbutton moves between a first position, a second position and a third position to control the power ON/OFF of the handheld computer, the backlight of the monitor and the cellular phone device.

### BACKGROUND OF THE INVENTION

1. Field of the Invention

The present invention relates to a handheld computer, and in particular to a handheld computer having a cellular phone function.

2. Description of the Related Art

Generally, the power switch of a conventional handheld computer, such as a PDA, only controls the power and the monitor backlight thereof. When the conventional handheld computer adds a wireless communication function, the power switch of the conventional handheld computer cannot control the power ON/OFF of the wireless communication function. The wireless communication function can operate, for example, in accordance with GSM or GPRS protocol. Thus, in addition to a power switch, the conventional handheld computer requires another switch to control the power ON/OFF of the wireless communication function when the wireless communication function is added to the conventional handheld computer.

Nevertheless, it is inconvenient for a user to control the conventional handheld computer with wireless communication function by two switches. In addition, the two switches cause increased volume for the conventional handheld computer with wireless communication function.

The invention provides a handheld computer having a monitor backlight and a cellular phone function. The handheld computer has a single power switch to control the power ON/OFF of the handheld computer, the monitor backlight and the cellular phone function.

### SUMMARY OF THE INVENTION

An object of the invention is to provide a handheld computer with a wireless communication function. The handheld computer comprises a main body, a cellular phone device, a monitor and a power switch. The monitor has a backlight. The cellular phone device is disposed in the main body. The monitor is disposed on the main body. The power switch is disposed on the main body and has a pushbutton. The pushbutton moves between a first position, a second position and a third position to control the power ON/OFF of the handheld computers, the backlight of the monitor and the cellular phone device.

Preferably, when the backlight of the monitor is in OFF mode, it is turned on when the pushbutton is moved to the second position and maintained in the second position for a predetermined time.

Preferably, when the backlight of the monitor is in ON mode, it is turned off when the pushbutton is moved to the second position and maintained in the second position for a predetermined time.

Preferably, when the cellular phone device is in OFF mode, it is turned on when the pushbutton is moved to the third position and maintained in the third position for a predetermined time.

Preferably, when the cellular phone device is in ON mode, it is turned off when the pushbutton is moved to the third position and maintained in the third position for a predetermined time.

Preferably, when the power of the handheld computer is in OFF mode, it is turned on when the pushbutton is moved to the third position and immediately released.

Preferably, when the power of the handheld computer is in ON mode, it is turned off when the pushbutton is moved to the third position and immediately released.

A detailed description is given in the following embodiment with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing a handheld computer having a cellular phone device in accordance with the present invention; and

FIG. 2 is an enlarged view of a portion of the handheld computer of FIG. 1 indicated by symbol “A”.

### DETAILED DESCRIPTION OF THE INVENTION

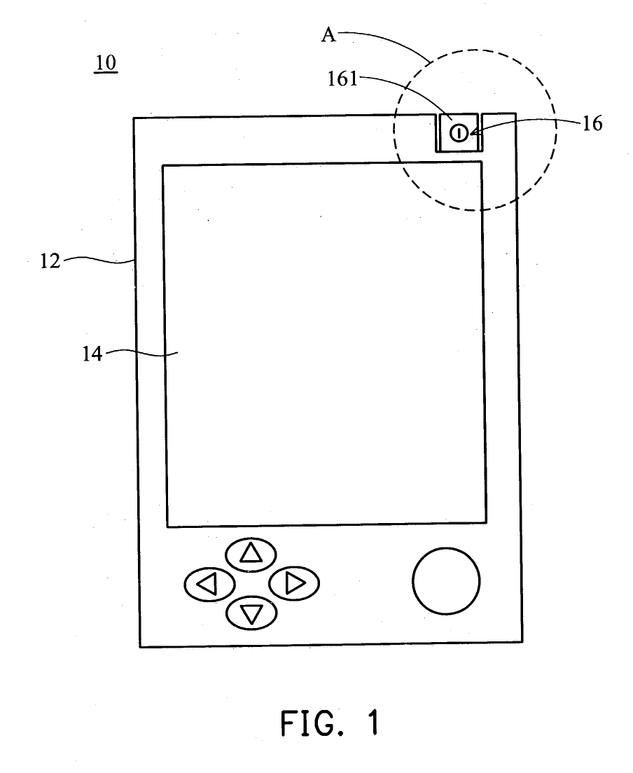

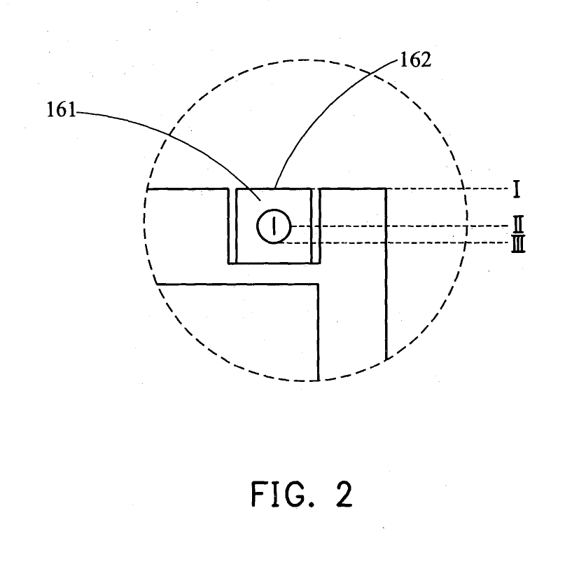

Referring to FIG. 1 and FIG. 2, the present handheld computer 10 comprises a main body 12, a monitor 14, a power switch 16 and a cellular phone device (not shown). The monitor 14 has a backlight. The cellular phone device is disposed in the main body 12. The monitor 14 and power switch 16 are disposed on the main body 12. The power switch 16 has a pushbutton 161 moving between a first position I, a second position II and a third position III. The pushbutton 161 controls the power ON/OFF of the handheld computer 10, the backlight of the monitor 14 and the cellular phone device.

As shown in FIG. 2, the pushbutton 161 has a top surface 162. The top surface 162 identifies the relative position of the pushbutton 161. When the pushbutton 161 is not actuated or moved, the top surface 162 is located in the first position I. The following is a detailed explanation of the operation of the power switch 16.

As shown in FIG. 1 and FIG. 2, when the backlight of the monitor 14 is in OFF mode, it can be turned on when the pushbutton 161 is moved to the second position II (the top surface 162 is located in the second position II) and maintained in the second position II for four seconds. Similarly, when the backlight of the monitor 14 is in ON mode, it can be turned off when the pushbutton 161 is moved to the second position II and maintained in the second position II for four seconds.

When the cellular phone device is in OFF mode, it can be turned on when the pushbutton 161 is moved to the third position III (the top surface 162 is located in the third position III) and maintained in the third position III for four seconds. Similarly, when the cellular phone device is in ON mode, it can be turned off when the pushbutton 161 is moved to the third position III and maintained in the third position III for four seconds:

When the power of the handheld computer 10 is in OFF mode, it can be turned on when the pushbutton 161 is moved to the third position III (the top surface 162 is located in the third position III) and immediately released. Similarly, when the power of the handheld computer 10 is in ON mode, it can be turned off when the pushbutton 161 is moved to the third position III and immediately released.

Specifically, the power switch 16 is not limited to single control mode. Namely, for example, when the backlight of the monitor 14 is in ON mode, the cellular phone device can be turned on or turned off by operation of the power switch 16 in respect to the third position III. Thus, the power switch 16 can control the backlight of the monitor 14, the cellular phone device and the power of the handheld computer 10 by multiple control modes.

While the invention has been described by way of examples and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A handheld computer, comprising:
a main body;
a cellular phone device disposed in the main body;
a monitor disposed on the main body, the monitor having a backlight; and
a power switch disposed on the main body and having a pushbutton, the pushbutton moving between a first position, a second position and a third position to control the power ON/OFF of the handheld computer, the backlight of the monitor and the cellular phone device.

2. The handheld computer as claimed in claim 1, wherein, when the backlight of the monitor is in OFF mode, it is turned on when the pushbutton is moved to the second position and maintained in the second position for a predetermined time.

3. The handheld computer as claimed in claim 1, wherein, when the backlight of the monitor is in ON mode, it is turned off when the pushbutton is moved to the second position and maintained in the second position for a predetermined time.

4. The handheld computer as claimed in claim 1, wherein, when the cellular phone device is in OFF mode, it is turned on when the pushbutton is moved to the third position and maintained in the third position for a predetermined time.

5. The handheld computer as. claimed in claim 1, wherein, when the cellular phone device is in ON mode, it is turned off when the pushbutton is moved to the third position and maintained in the third position for a predetermined time.

6. The handheld computer as claimed in claim 1, wherein, when the power of the handheld computer is in OFF mode, it is turned on when the pushbutton is moved to the third position and immediately released.

7. The handheld computer as claimed in claim 1, wherein, when the power of the handheld computer is in ON mode, it is turned off when the pushbutton is moved to the third position and immediately released.

8. A power switch for a handheld computer having a main body, a cellular phone device and a monitor having a backlight, the cellular phone device being disposed in the main body, the monitor being disposed on the main body, the power switch being disposed on the main body and having a pushbutton, the pushbutton moving between a first position, a second position and a third position, characterized in:
the backlight of the monitor turning on when the pushbutton is moved to the second position and maintained in the second position for a predetermined time, when the backlight is in OFF mode;
the backlight of the monitor turning off when the pushbutton is moved to the second position and maintained in the second position for a predetermined time, when the backlight is in ON mode;
the cellular phone device turning on when the pushbutton is moved to the third position and maintained in the third position for a predetermined time, when the cellular phone device is in OFF mode;
the cellular phone device turning off when the pushbutton is moved to the third position and maintained in the third position for a predetermined time, when the cellular phone device is in ON mode;
the power of the handheld computer turning on when the pushbutton is moved to the third position and immediately released, when the computer is in OFF mode; and
the power of the handheld computer turning off when the pushbutton is moved to the third position and immediately released, when the computer is in ON mode.
